(19) United States
(12) Patent Application Publication
(10) Pub. No.: US 2016/0143093 A1
(43) Pub. Date: May 19, 2016

(54) ILLUMINATING MICROWAVE HEATER, WITH ENERGY RECOVERY

(71) Applicants: Alberto PIZZETTI, Firenze (IT); Roberto GEMMA, Firenze (IT); Gianni CERZOSO, Prato (IT); Raoul CANGEMI, Firenze (IT)

(72) Inventors: Gianni Cerzoso, Prato (IT); Raoul Cangemi, Firenze (IT)

(21) Appl. No.: 14/900,954

(22) PCT Filed: Jun. 26, 2014
(86) PCT No.: PCT/IB2014/062631

§ 371 Date: Dec. 22, 2015

(30) Foreign Application Priority Data
Jun. 28, 2013 (IT) FI2013A000154

(51) Int. Cl. H05B 6/64

(52) U.S. Cl. CPC H05B 6/6444; H05B 6/6402

(57) ABSTRACT

Illuminating microwave heater, comprising at least o le magnetron radiating microwaves in a first chamber, impermeable, reflecting and shielding the microwaves; said first chamber being filled with ionized gas and comprising internally at least a second chamber, permeable to microwaves, adapted to contain liquid to feed into the radiators and heat absorbing tubes; said liquid being heated by friction, when radiated by the microwaves; said illuminating microwave heater comprising pipes connected to said at least one second chamber by means of devices adapted to prevent the microwaves from escaping from the first chamber; said ionized gas in plasma state when excited by the microwaves being adapted to generate light illuminating said first chamber at least internally.

### TECHNICAL FIELD

The present invention relates to the sector of heat generation systems, and in particular to an illuminating microwave heater, with energy recovery.

### BACKGROUND ART

With regard to heating by means of microwaves, the following patent documents are known: U.S. Pat. No. 4,178,494 * 10 Nov. 1977 11 Dec. 1979 Bottalico, Frank P micro-wave air heater; U.S. Pat. No. 4,236,056 * 29 Jan. 1979 25 Nov. 1980 Allen, Donald D Microwave Heater; U.S. Pat. No. 4,284,869 * 6 Mar. 1980 18 Aug. 1981 Pinkstaff, Leo W. Microwave water heater; U.S. Pat. No. 4,288,674 * 21 Apr. 1980 8 Sep. 1981 Councell, Graham D. Microwave actuated steam generator; U.S. Pat. No. 4,310,738 * 8 Feb. 1980 12 Jan. 1982 Mccann, Dennis Microwave fluid heating system; U.S. Pat. No. 4,388,511 * 20 May 1981 14 Jun. 1983 Jung Gmbh Microwave heating apparatus for circulable media; U.S. Pat. No. 4,417,116 * 2 Sep. 1981 22 Nov. 1983 Black, Jerimiah B. Microwave water heating method and apparatus; U.S. Pat. No. 4,559,429 * 29 Nov. 1984 17 Dec. 1985 The United States of America as represented by the United States Department of Energy Microwave Coupler and Method; U.S. Pat. No. 4,956,534 * 29 Apr. 1988 11 Sep. 1990 Martin, William A. Inverted frustum shaped microwave heat exchanger and applications thereof; U.S. Pat. No. 4,967,052 * 21 May 1990 30 Oct. 1990 Krapf, Edward J. Microwave heat pipe heating system; U.S. Pat. No. 5,064,494 * 10 Jun. 1988 12 Nov. 1991 Teroson GMBH Process for the at least partial curing of sealants and adhesives using pulsed microwave energy; U.S. Pat. No. 5,314,664 * 1 Apr. 1992 24 May 1994 Bodenseewerk Perkin-Elmer Gmbh Sample supply system having integrated microwave disintegration; U.S. Pat. No. 5,357,088 * 4 May 1992 18 Oct. 1994 Konica Corporation Method for melting a photographic composition gel to a sol using microwave energy; U.S. Pat. No. 5,512,734 * 20 Sep. 1994 30 Apr. 1996 Microonde Research Corp. Apparatus and method for heating using microwave energy; U.S. Pat. No. 5,919,218 * 30 Jan. 1995 6 Jul. 1999 Microwave Medical Systems Cartridge for in-line microwave warming apparatus; U.S. Pat. No. 6,064,047 * 16 Dec. 1996 16 May 2000 Izzo, Daniel R. Microwave hot water boiler heating system; U.S. Pat. No. 6,121,594 * 6 Nov. 1997 19 Sep. 2000 Industrial Microwave Systems, Inc. Method and apparatus for rapid heating of fluids; U.S. Pat. No. 6,271,509 3 Apr. 1998 7 Aug. 2001 Dalton Robert C. Artificial dielectric device for heating gases with electromagnetic energy; U.S. Pat. No. 6,380,525 * 2 Jul. 2001 30 Apr. 2002 Dalton Robert C. Artificial dielectric susceptor; U.S. Pat. No. 6,858,824 * 29 Dec. 2003 22 Feb. 2005 Alfred Monteleone Microwave heating system to provide radiation heat and domestic hot water; U.S. Pat. No. 6,888,116 * 27 Jan. 2003 3 May 2005 Robert C. Dalton Field concentrators for artificial dielectric systems and devices; U.S. Pat. No. 7,022,953 * 30 Jun. 2004 4 Apr. 2006 Fyne Industries, LLC Electromagnetic flowing fluid heater; U.S. Pat. No. 7,109,453 1 Feb. 2005 19 Sep. 2006 Keith A. Nadolski Microwave hot water system; U.S. Pat. No. 7,465,907 13 Aug. 2007 16 Dec. 2008 Raymond Martino Microwave boiler and hot water heater; DE4015639A1 * 15 May 1990 16 May 1991 Samsung Electronics Co., Ltd., Suwon, Kr Mit elektromagnetischen Wellen arbeitende heizvorrichtung; EP1746864A1 18 Aug. 2004 24 Jan. 2007 De Ruiter, Remco System with high energy efficiency for indirectly heating a target medium using electromagnetic radiation; EP2239995A1 * 7 Apr. 2009 13 Oct. 2010 Christian Zignani Device for heating a fluid for household or industrial use or for heating premises, using microwaves as its energy source; WO1998046046A1 * 15 Oct. 1998, 3 Apr. 1998 Robert C. Dalton Artificial dielectric device for heating gases with electromagnetic energy; WO2005067351A1 * 27 Dec. 2004 21 Jul. 2005 H2 Oh Inc. Microwave heating system for radiation heat and hot water; WO2006131755A1 * 9 Jun. 2006 14 Dec. 2006 William Dewhurst Heating apparatus and method.

The heating of rooms and similar spaces currently provides for use of pressurized gases delivered in pipes or supplied in containers, and a flame fed by said gases, adapted to heat the air in a heat exchangers through which the air is circulated; another known heating system for heating water is the use of a resistance boiler, which through pipes connected to radiators located in various points of one or more rooms receive the hot water heating the surrounding environment via radiation.

Both the systems described above are also used to heat running water.

Another system is the use of infrared lamps that radiate and heat the surfaces illuminated by the infrared light.

Some of the drawbacks of these prior art heating systems comprise high construction costs, large energy consumption, inefficiency and risks caused by the use of pressurized gas and a gas flame, not to mention the polluting substances emitted.

However, the greatest drawback is the length of time required to produce heating.

Similarly to the description above for heating, similar techniques have been used to create lighting: the oldest system is the flame, followed by the incandescence of a filament, by neon (gas ionized by the passage of electrical current) and then by the latest generation LEDs, once again energized with direct current.

### OBJECT AND SUMMARY OF THE INVENTION

An object of the present invention is to provide a simple, compact and reliable apparatus with heating and lighting function at low cost, efficient, which uses microwave energy to produce heat, light to illuminate environments and/or light to produce electricity, to heat environments and spaces as described above, adaptable for use, also in combination, with existing heat distribution systems in building structures and the like and light distribution systems such as optical fibers, concentrator bulbs and inert gas lamps.

A further object of the present invention is to provide a heating device with improved heating features relative to the different types of heating unit currently in use, free and non-polluting, with a closed circuit, with no explosive agents, with no flames, and in the interest of energy saving.

One more object of the present invention is to provide a new microwave heating apparatus that is versatile and highly flexible to cover a variety of heating and lighting requirements for environments, building structures and the like.

Yet another object of the present invention is to provide a new microwave heating apparatus that can be used in a complementary manner to other heating systems, including solar heating systems.

A further object of the present invention is the conversion of microwave energy into luminous energy by subjecting an inert gas to energy microwaves that convert it into plasma with consequent illumination.

A further object of the present invention is the partial recovery of the energy expended, through photovoltaic cells illuminated by the plasma disposed inside the device in question.

These and other objects, which will be more apparent below, are achieved with an illuminating microwave heater, comprising one or more microwave radiating magnetrons, preferably with a frequency greater than 1300 MHz, and more preferably equal to 2450 MHZ, in an impermeable metallic chamber, reflecting and shielding the microwaves; said chamber comprises filling with ionized gas (e.g. Argon) and comprises internally one or more chambers permeable to microwaves filled with liquid material (such as water) to feed into the radiators and heat absorbing tubes; said water will be heated by friction, when radiated by microwaves; the illuminating microwave heater is characterized by the presence of pipes connected to the heater by means of devices, such as mesh filters, adapted to prevent the microwaves from escaping from the chamber, the heater provides for the production of fluorescent light produced by the ionized gas in plasma state when excited by the microwaves.

Preferably, the illuminating microwave heater comprises lighting points (or more simply fluorescent “lights”), which are illuminated by the high plasma gas from these microwaves; these lighting points provide for the presence of meshing filters to protect against hazardous microwaves escaping from the chamber.

According to some preferred embodiments, the heater comprises solar panels suitable for receiving light generated by the ionized gas in plasma state, transforming it into electrical current, and yielding it when required by means of an accumulator or an inverter.

This heater provides for the combination of three energy conversion phenomena: microwaves that interact with fluids and plasma simultaneously, emitting heat and light recovered respectively by heat absorbers and by photovoltaic cells, these latter immersed in the luminous plasma, optimizing reduction of the dispersion of energy inside the heater.

Preferably, as stated, in the heater the high plasma gas by means of microwaves is converted into a source of luminous energy that can be partly recovered by the photovoltaic panel or panels.

Heater is intended both as the device adapted to produce heating of the liquid that will then be sent to the elements for heat exchange with the outside environment, and as the assembly formed by the device adapted to produce heating of the liquid with the elements for heat exchange associated.

The present invention also relates to a process for simultaneous heating and lighting, comprising:
a step of producing a plasma, inside a chamber, preferably metallic, starting from a gas, by means of excitation by microwaves, preferably of the type with frequency equal to 2450 MHz,
a step of heating a liquid, inside said chamber, both by said plasma and by said microwaves,
sending said heated liquid toward users responsible for heating,
producing light by said plasma,
using said light in lighting points directed toward the environment outside said chamber and/or on photovoltaic panels for producing electrical energy, inside said chamber.

### Physical Bases of Operation

For the fluids: a fluid passing through a chamber that absorbs and contains the energy from the microwaves is heated by the magnetron, a microwave generator tuned to the frequency of 2450 MHz; when a microwave oven is switched on, its compartment is saturated with microwaves. This particular frequency was chosen with the aim of transferring the maximum radiant energy generated by the magnetron to the fluids, without unnecessary waste. Other frequencies can be chosen if required. The most representative substance present in the heating circuits subjected to excitation is undoubtedly water. In fact, it was water that influenced the choice of the operating frequency of the magnetron. The water molecule is composed of atoms (Oxygen and Hydrogen) that have a different affinity (electronegativity) for electrons; the Oxygen atom strongly attracts electrons, acquiring a fraction of negative charge; the two Hydrogen atoms, less electronegative than oxygen, maintain a fraction of positive charge. Due to these fractions of electrical charge and to its geometry, the water molecule is hence a polarized molecule. When a polarized molecule is immersed in an electrical field it is oriented with its negative terminal facing the “positive” pole, while the positive terminal is facing the “negative” pole. If the electrical field is repeatedly reversed, the water molecule is obliged to reposition itself at each reversal of the field. At the frequency of 2450 MHz the water molecule reverses its position 2450 million times per second, without stopping for an instant; at a higher frequency rotation of the molecule would be interrupted before having completed the 180° rotation; for lower frequencies the water molecule would be able to rest between one rotation and the next. Therefore, at the frequency of 2450 MHz all the radiant energy of the magnetron is transferred to the water molecules and for this reason this frequency is called resonance frequency. In nature, there are other polarized molecules that are set in motion (and therefore heated) by microwaves, but, having a different resonance frequency than water, their heating is achieved with a yield below 100%.

For GASES. In the laboratory, a gas can be heated and ionized mainly using three methods: by passing a current through it, for example applying a voltage between two electrodes (direct current discharges); by emitting radio waves at suitable frequency (radiofrequency discharges); as in the previous point, but using microwaves (microwave discharges). Generally, from a microscopic point of view, these methods of forming a discharge (or plasma) are all equivalent: energy is supplied to the electrons bound to the nuclei, which at a certain point break free from the nucleus. Free electrons collide with other neutral atoms, releasing more electrons, and the process then proceeds in cascade until reaching a balance, which depends solely on the pressure of the gas and on the electric field applied.

### BRIEF DESCRIPTION OF DRAWINGS

Further features and advantages of the invention will be more apparent from the description of a preferred but not exclusive embodiment thereof, illustrated by way of non-limiting example in the accompanying drawings, wherein:

FIG. 1A represents an axonometric schematic view of the part of the heater according to the invention responsible for heating the liquid to send to elements for heat exchange with the environment, shown in FIGS. 1D and 1E;

FIG. 1B represents the same view as FIG. 1A, with some internal features highlighted with dashed lines;

FIG. 1C represents a schematic plan view, in cross section along the line IC of FIG. 1B;

FIG. 1D represents an axonometric schematic view of a heater according to the invention, comprising both the part responsible for heating the liquid to send to elements for heat exchange with the environment, and the elements for heat exchange with the environment;

FIG. 1E represents an axonometric schematic view both of the part of heater shown in FIG. 1A and of the schematic pipes responsible for heat exchange with the environment, connected to said part.

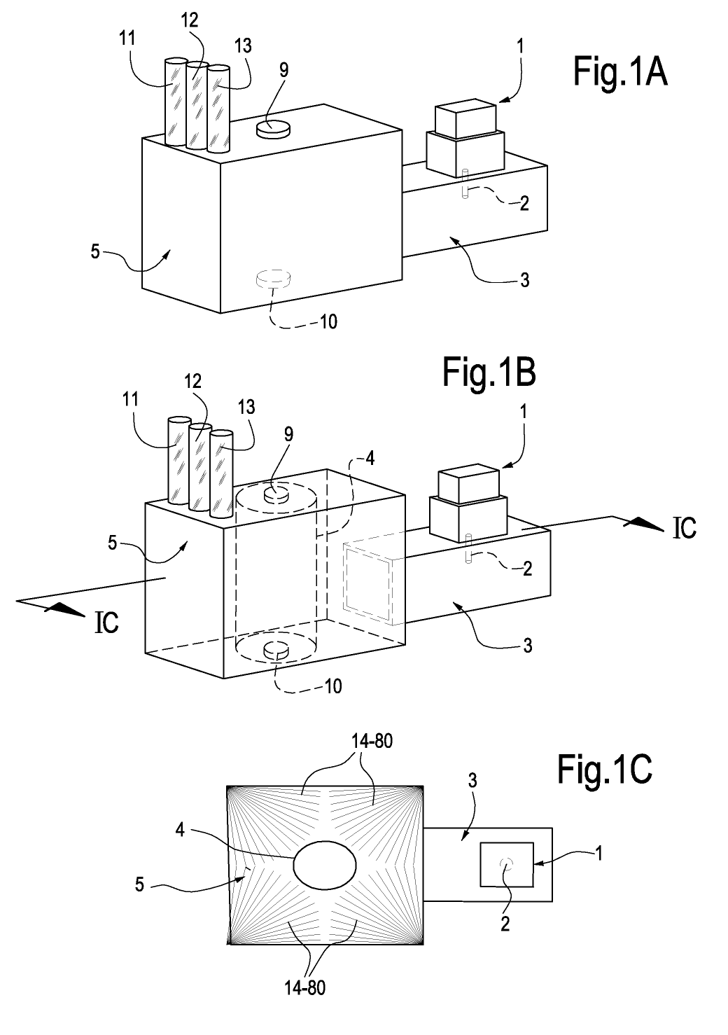

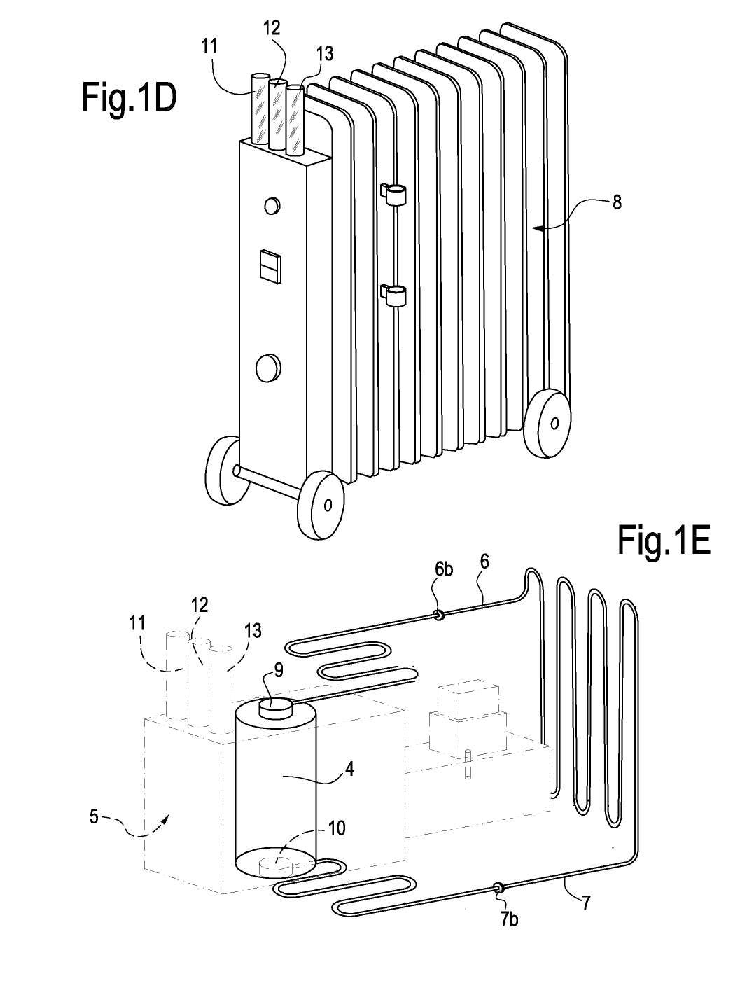

### DETAILED DESCRIPTION OF AN EMBODIMENT OF THE INVENTION

With reference to the aforesaid figures, the heater according to the invention comprises a first part responsible for heating the liquid to be sent to the pipes or elements for heat exchange with the environment, and responsible for producing light, and a second part comprising pipes or elements for heat exchange with the environment.

The first part comprises a first chamber 5, preferably metallic, in which a gas (preferably inert, in this example Argon, although other gases, such as helium, neon and the like, or mixtures of gases, could also be used) is turned into luminous plasma by means of microwaves. The reference number 1 indicates an electromagnetic wave generator, such as a magnetron, adapted to produce microwaves according to the prior art, for example with frequency equal to 2450 MHz. This magnetron 1, through an antenna 2, radiates a prechamber 3 (which forms part of the first chamber and waveguide), for resonance of the microwaves that energize the gas turning it, as stated, into luminous plasma. This plasma is distributed in the first chamber 5.

Inside the first chamber 5 is a second chamber 4, made of material permeable to microwaves, such as glass, containing the liquid (preferably water) to be heated, to send to the users, i.e. the pipes (or radiant elements, radiators or other centralized system; therefore, the heater can be equipped with a proper closed hydraulic circuit and can be positioned in any environment) 6 and 7 for heat exchange with the environment, connected with this second chamber 4. In particular, ducts 6B, 7B for connection to the pipes or radiators 6 and 7 lead from the second chamber.

The pipes 6 and 7 or 6B and 7B are connected to the second chamber by means of devices 9 and 10 adapted to prevent the microwaves from escaping from the first chamber 5, such as mesh filters of known type.

Preferably, circulation means, such as a pump, not indicated in the drawings, are associated with the pipes 6 and 7 or 6B and 7B.

Naturally, the heater can be equipped with a proper closed hydraulic circuit in which the water (or other liquid) to be heated circulates, passing through the second chamber (preferably equipped with feed inlets and discharge outlets of the hydraulic circuit) and can therefore be positioned in any environment, or can be equipped with a hydraulic circuit in which the water (or other liquid) to be heated circulates connected to another system, for example the system of one or more other heaters to create a system of heaters in series or in parallel. The hydraulic circuit of the illuminating heater can also be connected with a central heating system of a housing unit or complex.

Moreover, according to the invention it would also be possible for the part responsible for heating and for lighting (i.e. first chamber, second chamber and magnetron) to be located in a first environment and for the radiant heating elements to be located in a second environment, connected to the second chamber through long pipes 6 and 7. Further, in other embodiments, the lighting points can also be located at a distance from the first chamber, for example in a third environment, through light ducts or optical fibers or the like, capable of conveying light from the first chamber to the lighting points in the third environment.

The first chamber 5 is operatively connected, i.e. in fluid communication, with lighting points, such as bulbs 11, 12, and 13 made of transparent or almost transparent material. The area of connection between bulbs 11, 12 and 13 and chamber 5 is, for example, shielded by further devices 20, such as mesh filters of known type, to block the microwaves.

In this embodiment, a plurality of photovoltaic panels 14 . . . 80 are also present inside the chamber 5, variable in number according to requirements, the shape and position of which are indicated very schematically herein.

The light rays produced by the luminous plasma and the microwaves radiate the second chamber filled with water, also shielded from the first chamber 5 to protect users. The pipes 6, 7 of the heater (indicated with 8 in the assembly formed by the first part for producing hot water and second part for heat exchange with the environment) lead from the first chamber 4 and the connections for the radiator elements (or a centralized system) emerge by means of the pipes 6B and 7B.

The microwaves are shielded by the sleeves 9 and 10 by means of mesh filters (or metallic screens) of known type, to protect the rest of the system.

From the first chamber 5 the luminous plasma is distributed in the illuminating bulbs 11, 12, 13. The microwaves or other harmful radiations are shielded, at the connection interface between bulbs and first chamber, for example by further devices such as mesh filters or specific screens 20.

The photovoltaic panels 14 . . . 80 are energized by the light produced by the plasma and can produce electrical energy and yield it as required by means of an accumulator 81, an inverter or the like.

In practice, the luminous plasma illuminates the inside of the chamber 5. The heater is therefore internally “illuminating”. The light inside the chamber can be used in association with the photovoltaic panels inside the chamber 5, or can be conveyed to the outside, for example through lighting points such as bulbs or the like, for example light ducts, optical fibers, etc. or the light can be used both with the photovoltaic panels (internal illumination), and with the lighting points (external illumination).

According to the present invention, in some embodiments, the light emitted toward the outside environment can also be included in the bands of the non-visible, such as infrared or ultraviolet light (it can have a wavelength both in the visible and non-visible, or only visible or non-visible).

The liquid medium passing through the second chamber 4 is used to transfer the heat generated (in chamber 4) to the outside of the heater. The liquid medium is directed so as to receive the energy directly and to heat or pass over an absorbent material heated by molecular friction.

The method and the equipment described herein allow a noteworthy saving of energy, do not require ventilation, have no explosive agents, are without combustion, and do not produce toxic effects. The apparatus can be integrated with solar energy systems, in the sense that it can be coupled to a heat storage solar absorber providing hot air or water to the heat accumulator even in periods in which solar energy is at its lowest. It can also be supplied by current obtained from renewable energies (wind, photovoltaic, etc.).

It is understood that the description above merely represents possible non-limiting modes of implementation of the invention, which can vary in forms and arrangements without departing from the scope of the concept underlying the invention. Any reference numbers in the appended claims are provided purely for the purpose of facilitating the reading thereof in the light of the description above and of the accompanying drawings, and do not in any way limit the scope of protection.

1. An illuminating microwave heater, comprising at least one microwave generator in a first chamber, impermeable, reflecting and shielding the microwaves;
said first chamber being filled with ionized gas and comprising internally at least a second chamber, permeable to microwaves, adapted to contain liquid to feed into the radiators and heat absorbing tubes;
said liquid being heated by friction, when radiated by the microwaves;
said illuminating microwave heater comprising pipes connected to said at least one second chamber by means of devices adapted to prevent the microwaves from escaping from the first chamber; and
said ionized gas in plasma state when excited by the microwaves being adapted to generate light illuminating at least inside said first chamber.

2. The illuminating microwave heater according to claim 1, comprising at least one solar panel arranged inside said first chamber adapted to receive the light generated by the ionized gas ion plasma state and to convert it into electrical current, and to yield it when required by means of the accumulator, or of an inverter or the like.

3. The illuminating microwave heater according to claim 1, comprising at least one lighting, preferably fluorescent, illuminated by the ionized gas in plasma state when excited by the microwaves, positioned outside said first chamber, to illuminate the external environment.

4. The illuminating microwave heater according to claim 1, comprising at least one lighting point, preferably fluorescent, illuminated by the ionized gas in plasma state when excited by the microwaves, positioned outside said first chamber, to illuminate the external environment with light with wavelength in the visible, in the non-visible or in both ranges.

5. The illuminating microwave heater according to claim 3, comprising a plurality of said lighting points.

6. The illuminating microwave heater according to claim, wherein said at least one lighting point is a bulb made of material transparent to light.

7. The illuminating microwave heater according to claim 3, comprising further devices adapted to prevent the microwaves from escaping from said first chamber toward said lights.

8. The illuminating microwave heater according to claim 1, wherein said at least one microwave generator is adapted to emit microwaves with frequency greater than 1300 MHz and more preferably with frequency equal to 2450.

9. The illuminating microwave heater according to claim 8, wherein said at least one microwave generator is adapted to emit microwaves with frequency equal to multiples of 2450 MHz.

10. The illuminating microwave heater according to claim 1, wherein said at least one microwave generator is a magnetron.

11. The illuminating microwave heater according to claim 1, wherein said first chamber is metallic.

12. The illuminating microwave heater according to claim 1, wherein said gas is an inert gas.

13. The illuminating microwave heater according to claim 1, wherein said gas is, for example, argon, neon or helium.

14. The illuminating microwave heater according to claim 1, wherein said gas is formed by a mixture of gases.

15. The illuminating microwave heater according to claim 1, wherein said liquid is water.

16. The illuminating microwave heater according to claim 1, wherein said devices and/or further devices are mesh filters.

17. The illuminating microwave heater according to claim 1, wherein three energy conversion phenomena are combined: microwaves that interact with fluids and plasma simultaneously, emitting heat and light recovered respectively by heat absorbers and by photovoltaic cells, these latter immersed in the luminous plasma, optimizing reduction of the dispersion of energy inside the heater.

18. The illuminating microwave heater according to claim 2, wherein gas turned into plasma by means of microwaves is converted into a source of luminous energy partly recovered by the photovoltaic panel or panels.

19. A process for simultaneous heating and lighting, comprising:
a step of producing a plasma, inside a chamber, preferably metallic, starting from a gas, by means of excitation by microwaves, preferably of the type with frequency equal to 2450 MHz,
a step of eating a liquid, inside said chamber, both by said plasma and by said microwaves,
sending said heated liquid toward users responsible for heating,
producing light by said plasma, and
using said light in lighting points directed toward the environment outside said chamber and/or on photovoltaic panels for producing electrical energy, inside said chamber.
